(19) United States
(12) Patent Application Publication
(10) Pub. No.: US 2016/0268080 A1
(43) Pub. Date: Sep. 15, 2016

(54) REMOTE ACTIVATED AUTO UNPLUGGING DEVICE FOR ELECTRICAL EQUIPMENT

(71) Applicant: Roy Streicher, Batesville, IN (US)

(72) Inventor: Roy Streicher, Batesville, IN (US)

(21) Appl. No.: 15/047,803

(22) Filed: Feb. 19, 2016

Related U.S. Application Data
(60) Provisional application No. 62/130,022, filed on Mar. 9, 2015.

(51) Int. Cl. H01H 50/02; H01H 50/54

(52) U.S. Cl. CPC H01H 50/021; H01H 50/54

(57) ABSTRACT

A remote automated disconnector for a power plug including electrically activated plug retractor from a wall socket. A remote transmitter and receiver circuit allows for activation of the device from a distance by the user. A single pull type solenoid is in electronic communication with the receiver and direct interlinked physical contact with a retractable plug within the device allowing for select activation and unplugging from a wall socket.

This application claims the benefit of U.S. Provisional Application No. 62/130,022, filed Mar. 9, 2015.

### BACKGROUND OF THE INVENTION

1. Technical Field

This invention relates to devices for remotely unplugging an electrical plug from an electrical outlet.

2. Description of Prior Art

Prior art devices have been developed to assist in the remote unplugging of electrical plugs from a wall outlet which is important in certain related tasks that require the use of electrical powered machines such as in vacuuming, floor buffing, sanding, polishing and other power operated equipment. Such devices by design and use requirements must have a long power cord and therefore plugging and unplugging during use for relocation becomes a time consuming and efficiency reducing factor in the industry. Typically, when the machine reaches the length of its power cord it must be unplugged and then replugged in a new power port plug position for continued use requiring a repetitive time consuming task by the user.

A number of devices have been developed directed to this problem, see U.S. Pat. Nos. 5,800,189, 6,540,533, 7,234,953, and U.S. Publication 2002/0064983.

In U.S. Pat. No. 5,800,189 an apparatus and method for auto disconnecting of a power plug can be seen having a sensor to determine substantial sensation of current flow activating an ejector to eject the plug from the outlet.

U.S. Pat. No. 6,540,533 is directed to a remote electrical plug ejector having a solenoid that projects from the device into which the power device is plugged ejecting the device and the plug from the receptacle.

U.S. Pat. No. 7,234,953 claims an ejecting device for a power socket using a spring, moving gears and moving members with a lever shaped push member that engages and pushes the plug from the device.

Finally, in U.S. Publication 2002/0064983 a device is shown for removing and unplugging an electrical plug by use of a locking member and coil spring or alternately a solenoid activated by a remote switch based on current or voltage sensor within the circuit thereby ejecting the plug.

### SUMMARY OF THE INVENTION

A remote transmitter activation of a power disconnect device using a retractable internal power plug interconnected to a single pull solenoid and a power transfer circuit. Upon activation the solenoid pulls and retracts the interengaged guided plug from the wall socket releasing a disconnect device which then drops freely to the floor. The power equipment remains plugged into the remote unplugging device and can be easily retrieved by gathering the power equipment's power cord to a new location to be replugged.

### DESCRIPTION OF THE DRAWINGS

FIG. 1 is a partial cross-sectional view of the remote unplugging device of the invention.

FIG. 2 is a front elevational view of the remote unplugging device with portions shown in dotted lines.

FIG. 3 is a top plan view thereof with portions shown in dotted lines.

FIG. 4 is a graphic representation of the remote unplugging device in use illustrating the orientation and positioning of the device in relation to the remote control and powered equipment.

### DETAILED DESCRIPTION OF THE INVENTION

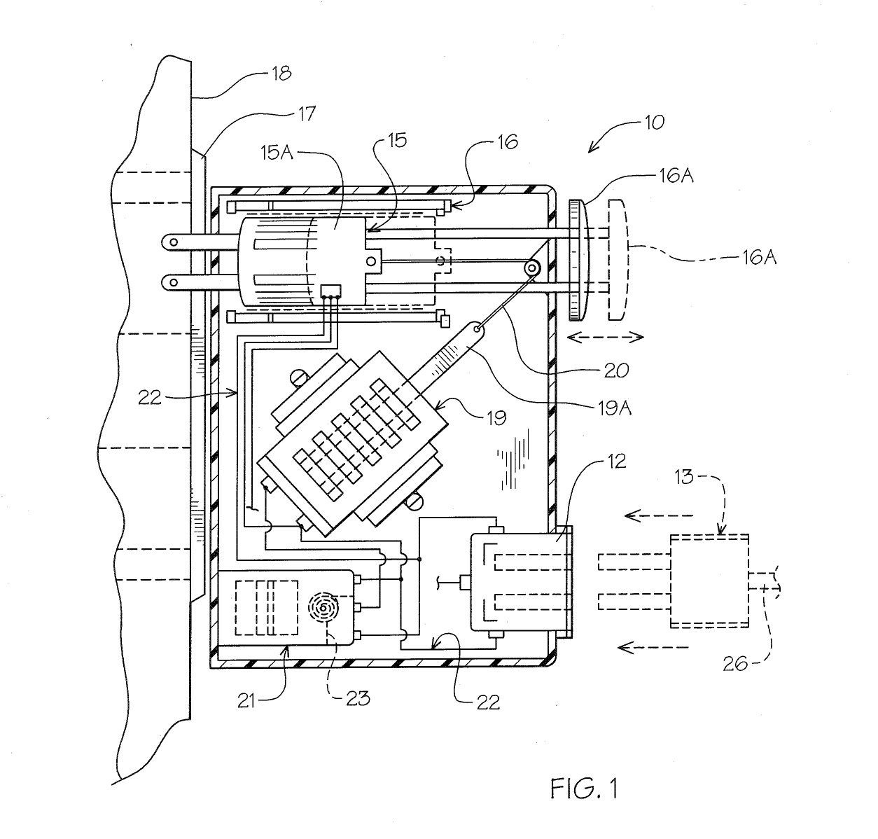

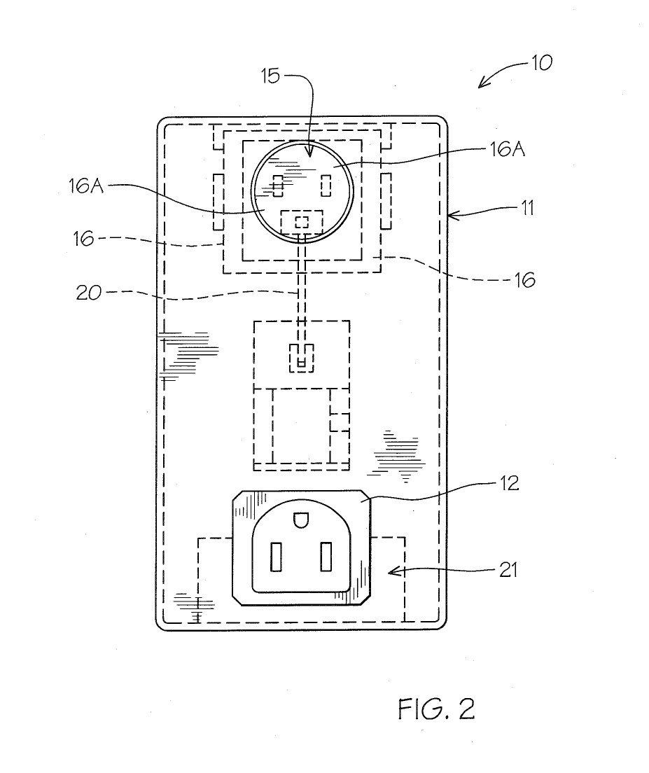

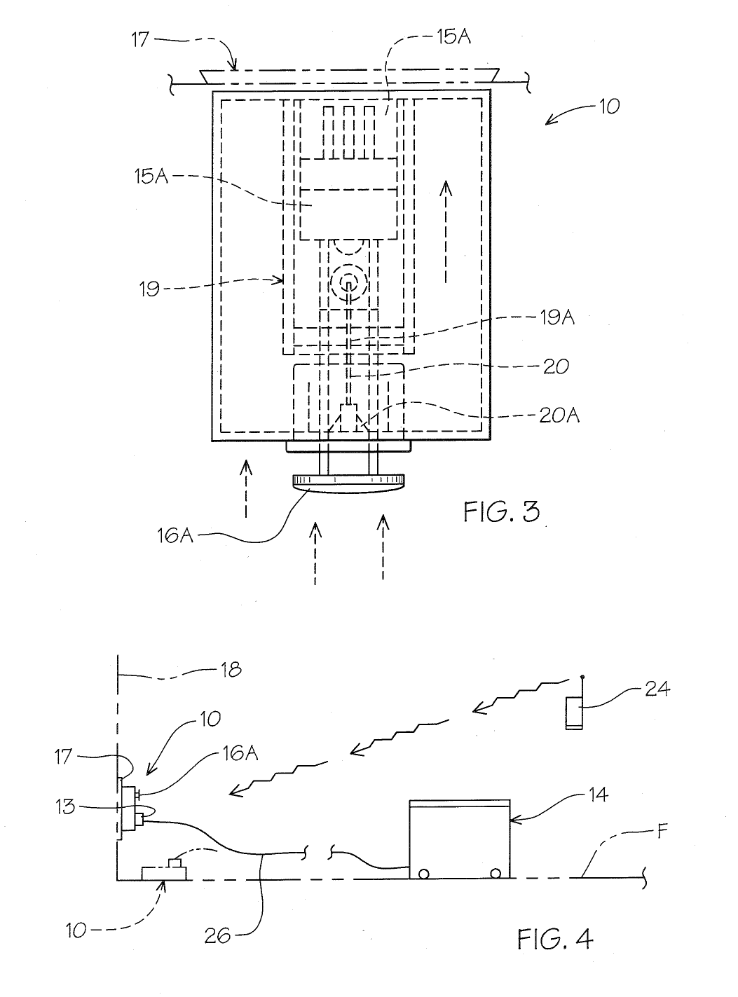

Referring now to FIGS. 1 and 2 of the drawings, a remote unplugging device 10 for power equipment of the invention can be seen. The unplugging device 10 has an exterior housing 11 of a generally rectangular configuration with an integrated power receptacle 12 within for receiving a power plug 13 of powered equipment 14 to be used as shown graphically also in FIG. 4 of the drawings as will be described in greater detail hereinafter.

A retractable power plug 15 is slidably disposed within a guide and support track assembly 16 within the housing 11. It will be seen that the housing 11 has multiple plug access openings therein that correspond to the power plug 15 allowing same to extend outwardly therethrough and to be registerably engaged into a wall socket 17 in a wall 18 in use as illustrated in FIG. 1 of the drawings.

The power plug 15 is engaged and moved by a pull type solenoid 19 which is mounted within the housing 11 and has an apertured activation rod 19A. A flexible linkage 20, in this example, extends from the activation rod 19A to an engagement fitting 15A on the retractable plug 15. A directional linkage guide 20A is engaged by the flexible linkage 20 to provide the angular offset end orientation for direct engagement with the retractable plug 15. It will be evident that a variety of different linkage configurations could be used such as a rigid double linked hinged configuration, not shown, to accomplish the same end result well within the parameters of the disclosure.

The plug guide and support track assembly 16 has a plug body engageable guide channels and a return element 16A interconnected thereto so as to effectively reset the power plug once the solenoid 19 is deactivated by the power control circuit.

An electronic transceiver module 21 is positioned within the housing 11 and is in electrical communication with the solenoid 19 and a power control circuit 22. The transceiver module 21 includes a transmitter and receiver and a power relay 23 and provides for remote activation of the solenoid 19 by an independently powered and mobile transmitter unit 24 located at a distance from the transceiver module 21.

In use, as illustrated in FIG. 4 of the drawings, the remote unplugging device 10 of the invention is plugged into the wall socket 17 using the retractable portion 15A of the plug 15. The power equipment 14 respective power plug 13 is correspondingly plugged into the remote unplugging device 10 via the integrated unit's power receptacle 12 as hereinbefore described. The remote transmitter unit 24 is typically located with the user adjacent the power equipment 14 which can be by use definition some distance from the wall plug 17 and the remote unplugger device 10.

Once the usable distance limit has been reached determined by the corresponding equipment's power cord 26, the user, not shown, can simply activate the remote transmitter 24 sending an electronic signal which is received by the transceiver module 21. The solenoid's power relay 23 will then be activated powering the solenoid 19 drawing the activation rod and pulling the retractable plug 15 effectively out of the wall socket 17.

Once so activated and released from the wall the remote unplugging device 10 will drop to the floor F and can be manually retrieved by the equipment's own power cord by the user. The remote unplugging device 10 can be reset by manually engaging the return element 16A extending from the housing 11, best seen in FIGS. 1 and 2 of the drawings, in reset ended position in broken lines and engaged position in solid lines.

This then allows the user to replug and reset the remote unplugging device 10 into a different power outlet, not shown, at a new location and continue using the power equipment 14 ready for remote activation.

It will thus be seen that a new and novel remote equipment electrical plug determination device has been illustrated and described. The unplugging device 10 will afford a safe simple equipment plug management system allowing for the unplugging and resetting of an adaptive integral interengaged retrieval system. It will be apparent to those skilled in the art that various changes and modifications may be made therein without departing from the spirit of the invention.

Therefore I claim:

1. A remote control power disconnect device for electrical equipment comprises,
a retractable power plug and interconnecting power receptacle,
said power plug movable from a first wall power outlet engagement position to a second retracted non-engaged position within said disconnect device, an electrical solenoid in communication with power plug and a remote control transceiver,
a remote transmitter in telemetric communication with said transceiver.

2. The remote control power disconnect device for electrical equipment set forth in claim 1 wherein said solenoid configured to be selectively activated by said transceiver.

3. The remote control power disconnect device for electrical equipment set forth in claim 1 wherein said solenoid has a flexible activation linkage extending to said retractable power plug.

4. The remote control power disconnect for electrical equipment set forth in claim 1 wherein said transceiver comprises,
a transmitter, a receiver and a power control circuit, said power control circuit in communication with a retractable power plug, said solenoid and the wall power outlet as a source of electrical power.

5. The remote control power disconnect device set forth in claim 1 wherein said retractable power plug further comprises,
a plug guide and support track with guide channels, a return element interconnected to said retractable power plug and extending from said disconnect device.

6. The remote control power disconnect device for electrical equipment set forth in claim 1 wherein the disconnect device is engaged and selectively disengaged from suspension in a power wall outlet.

7. The remote control power disconnect device for electrical equipment set forth in claim 1 wherein the power receptacle is adapted to receive plug-in power cords from the electrical equipment to be powered thereby.

8. The remote control power disconnect device for electrical equipment set forth in claim 4 wherein said receiver is adapted to receive transmitted signals from the remote transmitter for selective activation of the solenoid in electrical communication with the source of power.
